(19) United States
(12) Patent Application Publication
(10) Pub. No.: US 2006/0190286 A1
(43) Pub. Date: Aug. 24, 2006

(54) ELECTRONIC SYSTEMS AND METHODS FOR INFORMATION PROCESS AUTOMATION

(76) Inventors: Spenser Segal, Plymouth, MN (US); Pradeep Sinha, Medina, MN (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/275,966

(22) Filed: Feb. 7, 2006

Related U.S. Application Data
(60) Provisional application No. 60/651,024, filed on Feb. 8, 2005.

(51) Int. Cl. G06Q 99/00

(52) U.S. Cl. 705/1

(57) ABSTRACT

Systems and methods of the embodiments of the inventive subject matter provide for automation of information service work, for example the work of financial advisors and for enforcing and facilitating the adherence of such information workers to regulatory requirements.

### RELATED APPLICATIONS

This application claims priority to U.S. Provisional Application No. 60/651,024, filed Feb. 8, 2005.

### TECHNICAL FIELD

The inventive subject matter relates generally to process automation and more particularly to electronic automation of financial advisory services.

### BACKGROUND

There is now widespread and almost universal use of computers, software and electronic communications and data exchange in the information services industry in general and in the financial advisory services industry by example. These tools have increased productivity by a large measure over time by simplifying and automating many tasks that were previously carried out using tedious and time consuming manual calculations or report generation. Nonetheless, there continue to be many inefficiencies in the way these tools are used day in and day out, and also in the way the tools interact with one another. Further, there have been important changes in the regulation of the financial advisory services industry. These changes have imposed more exacting regulations on the industry, and now require more vigilant compliance by financial advisors and their employers, agents or affiliations.

### SUMMARY

Systems and methods of the embodiments of the inventive subject matter provide for automation of information service work, for example the work of financial advisors and for enforcing and facilitating the adherence of such information workers to regulatory requirements.

### BRIEF DESCRIPTION OF THE DRAWING

FIGS. 1-3 illustrate example system embodiments of the inventive subject matter; and

FIGS. 4-6 illustrate example method embodiments of the inventive subject matter.

### DETAILED DESCRIPTION

In the following description, numerous specific details are set forth. However, it is understood that embodiments of the invention may be practiced without these specific details. In other instances, well-known circuits, structures, and techniques have not been shown in detail to avoid obscuring the understanding of this description. Note that in the description, references to “one embodiment” or “an embodiment” mean that the feature being referred to is included in at least one embodiment of the invention. Further, separate references to “one embodiment” in this description do not necessarily refer to the same embodiment; and, neither are such embodiments mutually exclusive, unless so stated and except as will be readily apparent to those of ordinary skill in the art. Thus, the present invention can include any variety of combinations and/or integrations of the embodiments described herein. Moreover, in this description, the phrase “exemplary embodiment” means that the embodiment being referred to serves as an example or illustration.

Described below are systems and methods for creating electronic workflows for use, in one example embodiment, for implementing written policies and procedures and preventing violations of the Advisor's Act as set forth in SEC Rule 206 and 204a1. According to this Act, there are requirements, for instance, for enforcing policies that enforce proper conduct in accordance with fiduciary duties. The Act requires, also, for instance, that financial service companies keep copies of policies and records and an audit trail demonstrating at least an annual review of compliance. According to one example embodiment, there is provided a process wherein existing policies and procedures are reviewed and mapped against regulatory requirements, and augmented as necessary to address compliance and audit requirements. In the process, the existing or current processes are captured and translated into workflow diagrams. The workflow is then additionally analyzed for cost, consistency and the effectiveness of the procedures. From this analysis recommendations to improve the processes are formulated.

According to one example embodiment of the inventive subject matter, there are provided systems and methods for automating and streamlining procedures based on the analysis, such that the procedures generate required audit trails which prove implementation without extra effort by employees. In addition, the workflow may integrate with current systems using flexible technologies, and provide tools that allow employees to learn and perform compliance functions in one easy process. Further, the method and system may highlight who does and does not complete responsibilities. Such reporting may be generated instantaneously. This allows a using organization to prove the implementation of its policies and procedures and build tools that enable the organization to train employees and agents in compliance procedures. While the agents are performing the procedures in a workflow, the workflow ensures that the processes meet regulations and are consistently applied. Activities are documented while they are occurring, providing instantaneous records of what was done by whom, when and where. Thus, the process and system provide for identifying any or all 10 compliance areas based on those areas. Regulatory requirements may be imposed by laws or by rules enacted in accordance with laws, or in another example embodiment may be imposed by voluntary industry standards such as generally accepted accounting principles.

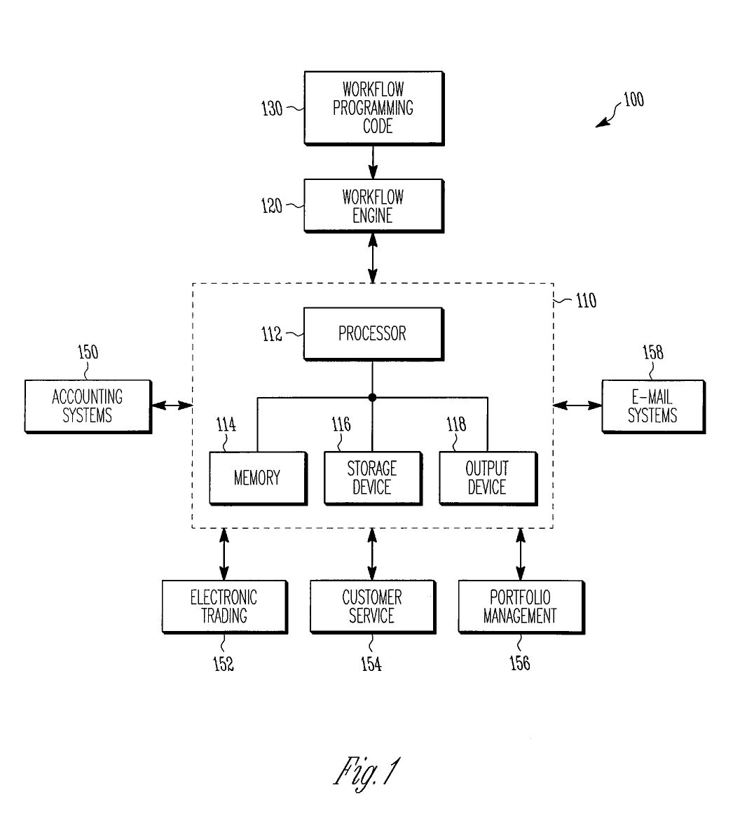

Referring now to FIG. 1, there is shown a block diagram of an electronic workflow system 100 according to one example embodiment of the inventive subject matter. Workflow system 100 includes processing module 110 including one or more processors 112, memories 114 and storage devices 116. One or more display monitors or output devices 118, such as printers, are also provided. A workflow engine 120 executes on processing module 110. Workflow engine 120 may be, for example but not by limitation, the Websphere™ system offered by IBM Corporation, or Biztalk Server offered by Microsoft Corporation. Workflow programming code 130, one generalized of which is the Business Process Execution Language (BPEL) can be executed by the workflow engine 120 to perform electronic workflow operations. BPEL code may conform with the BPEL industry generalized published by a consortium of companies including IBM, BEA Systems, and Microsoft. BPEL is, however, just one example of workflow programming code and the inventive subject matter is in no way limited to the use of code compliant with that generalized. Workflow operations may be, for example but not by limitation, tasks and subtasks assigned to and performed by people or the workflow system 100 or systems connected or interacting with it, and forming a process used to automate data processing operations used in a business setting, such as accounting operations, generation of documents, providing reports, on-line access to data and other operations.

Workflow system 100 may also be connected, as indicated, to one or more external systems such as accounting systems 150, electronic trading systems 152 (for trading, for instance, debt and equity instruments), customer service systems 154, portfolio management systems 156, e-mail systems 158 and any other sources, repositories or processing destinations for data. In one embodiment, but not by way of limitation, workflow system 100 may interface with such systems using an industry standard interface such as XML/SOAP or other web services based protocols, allowing system 100 to query, write and exchange data with the external systems.

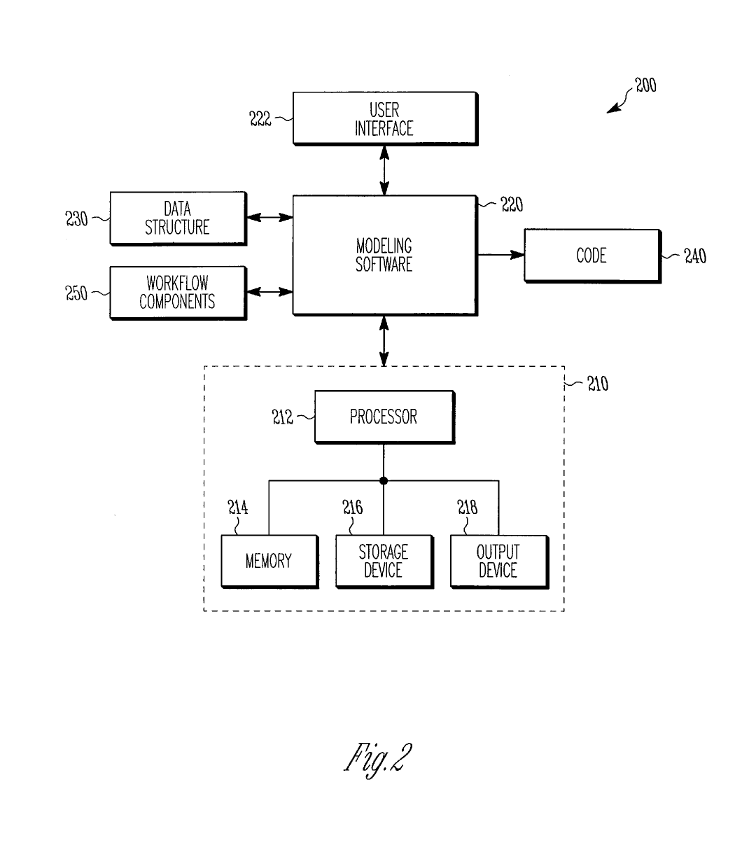

Referring now to FIG. 2, there is illustrated a process modeling system 200. Process modeling system 200 includes processing module 210 including one or more processors 212, memories 214 and storage devices 216. One or more display monitors or output devices 218, such as printers, are also provided. A modeling engine or module 220 executes on processing module 210. Software module 220 may be, for example but not by limitation, the WebSphere Business Integration Modeler offered by IBM Corporation, or Microsoft Visio offered by Microsoft Corporation. Modeling engine or module 220 provides a user interface 222 (through a display device or monitor for instance) allowing users to model a workflow as a flow diagram. The modeled flow diagrams are represented by modeling data stored in a process model data structure 230, which is interpreted for display and manipulation on a computer monitor. Software module 220 may, in one mode of operation, compile or otherwise process the modeling data to generate workflow programming code such as BPEL code 240 that can be executed by the workflow operating system 220 to perform electronic workflow operations. Data structure 230 or code 240 may be stored in memory 214 or storage devices 216 for access by the system 200.

Creation of generalized workflows (for example workflows that are generally applicable to a particular set of tasks and can be customized) may be formed from a library of workflow components 250 (which also can be stored in memory 214 or storage 216) that have been previously assembled, wherein such operations may include, for instance, tasks and subtasks used to collect data from an external system, send data to an external system, create merge documents, and escalate an issue. As such, workflow modeling system 200 may include a data structure and storage area for storing a component library of generalized or modifiable workflow data that can be used to build generalized workflows, or modify generalized workflows. Components 250 also may be made compliant with SEC regulations.

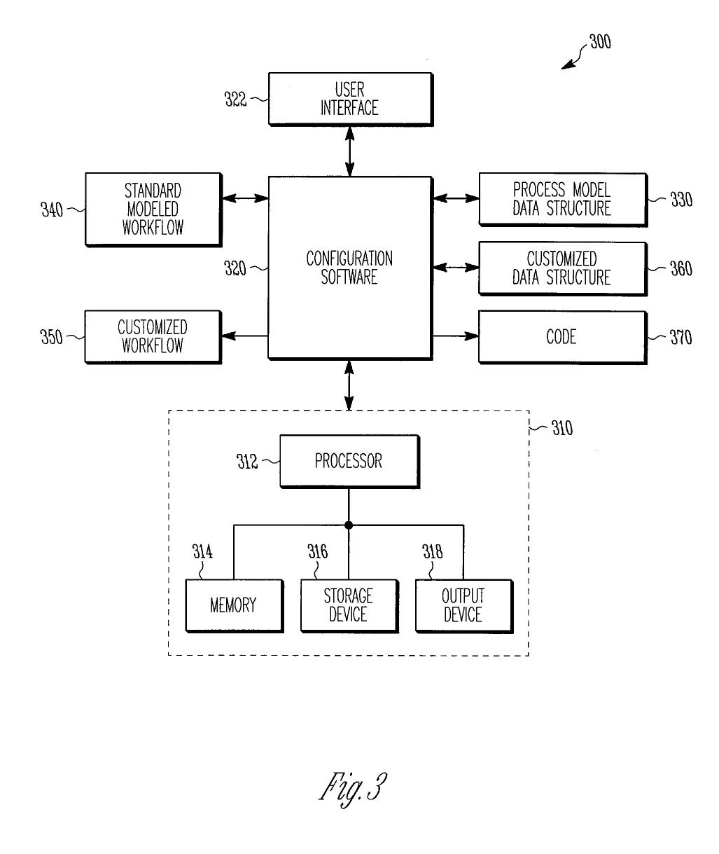

Referring now to FIG. 3, there is illustrated a configuration system 300. Configuration system 300 includes processing module 310 including one or more processors 312, memories 314 and storage devices 316. One or more display monitors or output devices 318, such as printers, are also provided. A configuration software module 320 executes on processing module 310. Configuration software module 320 includes a user interface 322 allowing users to configure a generalized modeled workflow 340 that may, for example, be represented by a process model data structure 330, such as the model data structure 230 discussed above.

According to one example embodiment of the inventive subject matter, the generalized modeled workflow 340 may represent an electronic workflow used by a financial advisor or his staff to:
1) qualify, accept and set up a new client to be represented by the advisor;
2) service the client, for example, to provide investment advice or suggestions to the client or conduct trades in the client's account; or
3) verify or monitor that the advisor is meeting his or her fiduciary obligations.

Each generalized modeled workflow 340 is designed to assure compliance with one or more United States Securities and Exchange Commission (SEC) regulations governing the provision of services by a financial advisor or financial service company to a client of the advisor or company. Such SEC regulations are, in one example embodiment, SEC Rule 206-4-7, which sets forth ten policies that financial advisor service providers are required to implement in their organizations. Such policies include, for example, the following:
1. Portfolio Management, including the allocation of investment opportunities among clients and the consistency of portfolios with clients' investment objectives, disclosures and regulatory restrictions.
   Some examples of conduct that compliance procedures should be designed to prevent are:
   Style drift—chasing returns;
   Violation of investment restrictions;
   Window dressing and portfolio pumping;
   Unfair allocation of securities, including initial public offerings;
   Use of 17a-7 and 10f-3 transactions to dump unfavorable securities; and
   Cherry picking.
2. Trading practices, including satisfying the duty of best execution and the use of client commissions to obtain execution, research or other services. Examples of conduct that compliance procedures should be designed to prevent include:
   Failure to obtain best execution;
   Failure to periodically and systematically review execution quality and to route and reroute orders accordingly;
   Use of commissions to obtain items/services outside the safe harbor of 28(e), and without adequate disclosure to clients/shareholders;
   Interpositioning an affiliated broker-dealer;
   Use of commissions outside of 12b-1 to pay for distribution, or use of commissions to pay for client referrals, without disclosure; and
   Failure to clearly disclose to clients the use of their commission dollars.
3. Proprietary trading of the adviser and personal trading by employees. Examples of conduct that compliance procedures should be designed to prevent include:
   Market timing, insider trading, front-running or other abusive personal or proprietary trading;
   Untimely or failure to report personal securities transactions;
   Violations of the codes of ethics; and
   Failure to properly identify and monitor trading by all access persons.
4. The accuracy of disclosures made to investors, clients and regulators, including account statements and advertisements. Examples of conduct that policies and procedures should be designed to prevent include:
   Inaccurate or misleading performance numbers;
   Inadequate supporting documentation for performance claims;
   Misleading advertisements;
   Inappropriate use of after-tax returns; and
   Any statement in an ADV, brochure, prospectus, SAI or other document that is not 100% accurate.
5. Safeguarding of client assets from conversion or misuse. Examples of conduct that policies and procedures should be designed to prevent include:
   Improper or inadvertent access to client assets;
   Unauthorized trading in clients' accounts;
   Improper disclosure of client account information;
   Delivery of false custodial statements to clients; and
   Discrepancies between the records of the firm and custodian.
6. Creating and maintaining accurate books and records. Examples of conduct that policies and procedures should be designed to prevent include:
   Failure to maintain and have accessible all required books and records, including emails;
   Failure to protect records and information from unauthorized access and manipulation;
   Maintaining inaccurate books and records—e.g., revenue and expense numbers are not accurate or timely; and
   Failure to produce business records required by inspection staff.
7. Marketing advisory services, including the use of solicitors. Examples of conduct that policies and procedures should be designed to prevent include:
   Failure to disclose or inadequate disclosure of solicitation arrangements;
   Failure of solicitor to deliver adviser's ADV;
   Failure to disclose payments to employees for referrals; and
   Failure to contract for solicitation.
8. Valuing client holdings and assessing fees. Examples of conduct that policies and procedures should be designed to prevent include:
   Illiquid or fair-valued assets not valued appropriately, or not back-tested; and
   Inaccurate computation of fees, or fees based on inaccurate computation of client assets.
9. Protecting the privacy of client records and information. Examples of conduct that policies and procedures should be designed to prevent include:
   Failure to safeguard the privacy of clients;
   Failure to notify clients of policies on safeguarding;
   Lack of verification that client data is compiled accurately; and
   Integrity of client data is not protected from unauthorized changes.
10. Business continuity. Examples of conduct that policies and procedures should be designed to prevent include:
   Failure to prepare for, and test operations during, human or natural emergencies;
   Failure to provide for availability of critical personnel and systems;
   Failure to verify continuity plans of third party providers; and
   Failure to protect records from unplanned destruction.

According to one example embodiment, the generalized modeled workflow 340 provides one or more configuration options that may be selected by a user such as a financial services organization to customize the workflow 340 to their particular liking or needs to create a customized, SEC compliant workflow 350. According to another example embodiment, the options presented to a user designed to be compliant with any SEC regulations applicable to the workflow in question. The options may be presented in drop down menus or in one or more other screens providing mechanisms to input configuration choices. Accordingly, a user is allowed to configure a workflow to their particular needs or liking while at the same time knowing that any such configuration will result in a customized workflow that is compliant with SEC regulations. Configurations may include such items as names, addresses, roles, audit trails options, escalation options, timing options and other options.

Accordingly, according to one example embodiment, a user or user organization may use the configuration system 300 to configure and customize one or more generalized, SEC compliant workflows for use, for example, by its financial advisors. Because the workflows 350 are known to be compliant with SEC regulations, the organization gains confidence that its financial advisors will act in accordance with SEC regulations and policies provided that they follow the customized workflows 350.

According to another example embodiment, the customized workflows 350 may also be further modified manually to achieve alternate or additional workflow, but such workflows would not necessarily be known to satisfy SEC regulations without further review and clearance by appropriate personnel.

A customized workflow 350 may be represented by configuration data stored in a customized process model data structure 360, which may be interpreted for display and manipulation on a computer monitor. Software module 320 may, in one mode of operation, compile or otherwise process the customized configuration data to generate customized workflow programming code such as BPEL code 370 that can be executed by the workflow operating system 120 to perform customized electronic workflow operations.

According to one example embodiment, a workflow may be modeled in a hierarchy of policy to procedure to rule to workflow programming code such as BPEL code, wherein a procedure is designed to implement a policy, and the procedure includes one or more rules, and the rules are used to generate workflow programming code such as BPEL code.

According to one example embodiment, a SEC compliant workflow 340 or 350 implements audit capabilities to conform to SEC audit requirements, and escalation capabilities, wherein excursions from policy compliant actions can be escalated to parties responsible for managing or auditing compliance with SEC regulations or other compliance.

According to another example embodiment, BPEL code 370 executes on the workflow system 100 and provides a workflow interface for use by a financial service advisor. System 100 may also provide an interface for an administrator permitting the setting of personnel, roles and privileges and to specify how escalation may occur such as by e-mails to certain personnel. A compliance dashboard display may be provided by the BPEL code 370 to allow personnel to monitor a workflow and make sure that the proper steps have been followed, for example, to monitor whether proper documentation has been submitted.

According to another example embodiment, a generalized workflow is assembled by first studying a process used by a financial advisor, for example, by observing the financial advisor, and then modeling the observed behavior, and finally adding compliance steps or operations that assures that the particular workflow being performed is compliant with applicable SEC regulations.

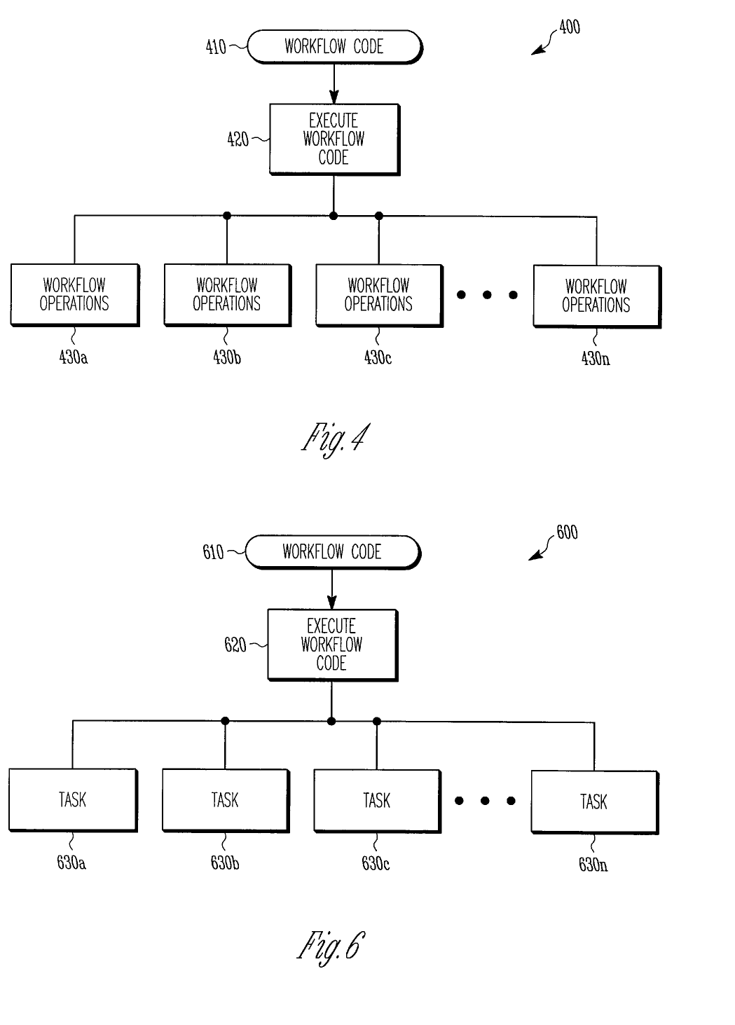

Referring now to FIG. 4, there is shown a block diagram of an electronic workflow process 400. Workflow programming code 410, such as BPEL code, is executed 420 by a workflow operating system. A plurality of electronic workflow operations 430ₐ to 430ₙ are performed. As noted above, workflow operations may be, for example but not by limitation, tasks and subtasks forming a process used to automate data processing operations used in a business setting, such as accounting operations, generation of documents, providing reports, on-line access to data and other operations.

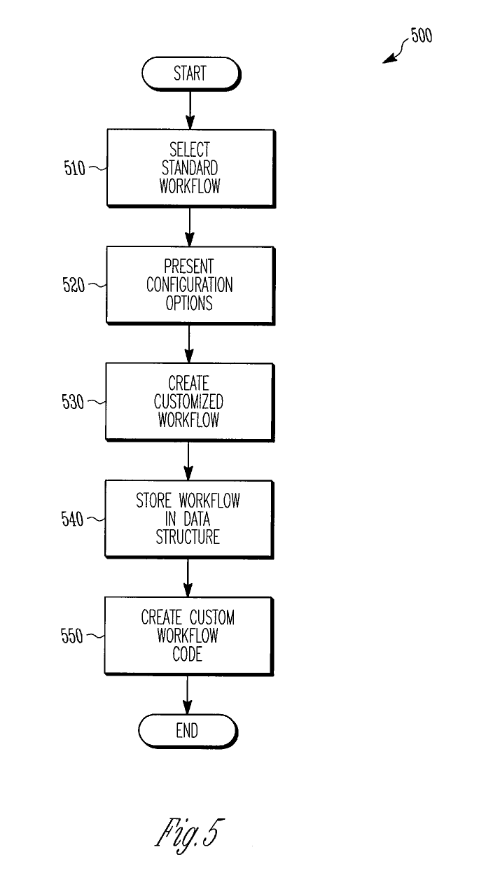

Referring now to FIG. 5, there is illustrated a workflow configuration process 500. A “generalized” modeled workflow is selected 510 that may, for example, be represented by a process model data structure, such as the model data structure 230 discussed above. In one example embodiment, the generalized modeled workflow may represent an electronic workflow used by a financial advisor, as noted above. One or more configuration options are presented 520 that may be selected by a user such as a financial services organization to customize the workflow to their particular liking or needs to create a 530 customized, SEC compliant workflow. The customized workflow may be represented by configuration data stored 540 in a customized process model data structure. The customized configuration data is used to generate 550 customized workflow programming code such as BPEL code that can be executed by the workflow operating system to perform customized electronic workflow operations.

Referring now to FIG. 6, there is illustrated a workflow process 600 wherein BPEL code 610 is executed 620 on a workflow engine. The workflow implements a series of tasks and subtasks 630ₐ to 630ₙ to implement a workflow that is compliant with SEC regulations.

Thus, there has been described above in one embodiment electronic workflow creation and execution systems and methods for use in the financial services industry. According to another embodiment, the creation and execution systems and methods may be used for industries or applications other than in the financial services industry. For example, the systems and methods are applicable to the legal services industry to assure compliance with laws or regulations, or to any industry that is regulated by law or rule or by voluntary compliance with an industry standard.

What is claimed is:

1. A method comprising:
maintaining a first workflow data structure containing electronically accessible information indicative of an automated workflow used to perform the work of a financial advisor, wherein the information contained by the workflow data structure is adapted to enforce automated compliance with one or more regulatory requirements when the automated workflow is performed;
presenting a set of configuration choices for the first workflow to a user and the user selecting desired configurations;
in response to the selected desired configurations, creating a user-configured version of the first workflow data structure to be used by the financial advisor;
wherein the information contained by the workflow data structure is adapted to enforce automated compliance with one or more of the regulatory requirements when the automated workflow is performed;
executing the workflow using an electronic workflow engine wherein the workflow information drives at least in part the electronic workflow performed by the engine; and
in response to execution of a workflow using workflow information, recording an electronic audit trail accessible to establish that a workflow executed on the workflow engine is compliant with one or more of the regulatory requirements.

2. A method according to claim 1 further wherein the regulatory guidelines are divided into practice areas and each area has several workflows targeting different processes that are to be used to address the broad guidelines specified in the practice area.

3. A method according to claim 2 further wherein the workflow is aware of the practice area and implements policies to enforce SEC regulations.

4. A method according to claim 2 wherein the practice area is insider trading.

5. A method comprising:
creating a workflow data structure containing electronically accessible information indicative of an automated workflow used to perform the work of the financial advisors;
wherein the information contained by the workflow data structure is adapted to enforce automated compliance with one or more regulatory requirements when the automated workflow is performed;
executing the workflow using an electronic workflow engine wherein the workflow information drives at least in part the electronic workflow performed by the engine; and
in response to execution of a workflow using workflow information, recording an electronic audit trail accessible to establish that a workflow executed on the workflow engine is compliant with one or more of the regulatory requirements.

6. A method according to claim 5 further including prebuilt workflow components that can be configured in the workflow to reflect customized processes

7. A method according to claim 5 further including extensible components built to address custom work items for specific organizations.

8. A system comprising:
one or more data storage mediums and a first workflow data structure stored in the one or more data storage mediums and containing electronically accessible information indicative of an automated workflow used to perform the work of a financial advisor, wherein the information contained by the workflow data structure is adapted to enforce automated compliance with one or more regulatory requirements when the automated workflow is performed;
a configuration engine to present a set of configuration choices for the first workflow to a user and the user selecting desired configurations, and in response to the selected desired configurations, create a user-configured version of the first workflow data structure to be used by the financial advisor, wherein the information contained by the workflow data structure is adapted to enforce automated compliance with one or more of the regulatory requirements when the automated workflow is performed; and
a workflow engine to execute the workflow wherein the workflow information drives at least in part the electronic workflow performed by the engine and wherein the workflow engine records an audit trail in response to execution of the workflow, the electronic audit trail serving to at least help establish that a workflow executed on the workflow engine is compliant with one or more of the regulatory requirements.

9. A system according to claim 8 further wherein the regulatory guidelines are divided into practice areas and each area has several workflows targeting different processes that are to be used to address the broad guidelines specified in the practice area.

10. A system according to claim 9 further wherein the workflow is aware of the practice area and implements policies to enforce SEC regulations.

11. A system according to claim 9 wherein the practice area is insider trading.

12. A system comprising:
one or more data storage mediums to store a workflow data structure containing electronically accessible information indicative of an automated workflow used to perform the work of a financial advisor, wherein the information contained by the workflow data structure is adapted to enforce automated compliance with one or more regulatory requirements when the automated workflow is performed; and
an electronic workflow engine to execute the workflow using an electronic workflow engine wherein the workflow information drives at least in part the electronic workflow performed by the engine, electronic workflow causing an electronic audit trail to be recorded to establish that a workflow executed on the workflow engine is compliant with one or more of the regulatory requirements.

13. A system according to claim 12 further including prebuilt workflow components that can be configured in the workflow to reflect customized processes

14. A system according to claim 12 further including extensible components built to address custom work items for specific organizations.

15. A method comprising:
maintaining a first workflow data structure containing electronically accessible information indicative of an automated workflow used to perform the work of a information worker, wherein the information contained by the workflow data structure is adapted to enforce automated compliance with one or more regulatory requirements when the automated workflow is performed;
presenting a set of configuration choices for the first workflow to a user and the user selecting desired configurations;
in response to the selected desired configurations, creating a user-configured version of the first workflow data structure to be used by the information worker;
wherein the information contained by the workflow data structure is adapted to enforce automated compliance with one or more of the regulatory requirements when the automated workflow is performed;
executing the workflow using an electronic workflow engine wherein the workflow information drives at least in part the electronic workflow performed by the engine; and
in response to execution of a workflow using workflow information, recording an electronic audit trail accessible to establish that a workflow executed on the workflow engine is compliant with one or more of the regulatory requirements.

16. A method according to claim 15 further wherein the regulatory guidelines are divided into practice areas and each area has several workflows targeting different processes that are to be used to address the broad guidelines specified in the practice area.

17. A method according to claim 16 further wherein the workflow is aware of the practice area and implements policies to enforce SEC regulations.

18. A method according to claim 16 wherein the practice area is insider trading.

19. A method comprising:
creating a workflow data structure containing electronically accessible information indicative of an automated workflow used to perform the work of the information workers;
wherein the information contained by the workflow data structure is adapted to enforce automated compliance with one or more regulatory requirements when the automated workflow is performed;
executing the workflow using an electronic workflow engine wherein the workflow information drives at least in part the electronic workflow performed by the engine; and
in response to execution of a workflow using workflow information, recording an electronic audit trail accessible to establish that a workflow executed on the workflow engine is compliant with one or more of the regulatory requirements.

20. A method according to claim 19 further including prebuilt workflow components that can be configured in the workflow to reflect customized processes

21. A method according to claim 19 further including extensible components built to address custom work items for specific organizations.

22. A system comprising:
one or more data storage mediums and a first workflow data structure stored in the one or more data storage mediums and containing electronically accessible information indicative of an automated workflow used to perform the work of a information worker, wherein the information contained by the workflow data structure is adapted to enforce automated compliance with one or more of the regulatory requirements when the automated workflow is performed;
a configuration engine to present a set of configuration choices for the first workflow to a user and the user selecting desired configurations, and in response to the selected desired configurations, to create a user-configured version of the first workflow data structure to be used by the information worker, wherein the information contained by the workflow data structure is adapted to enforce automated compliance with one or more of the regulatory requirements when the automated workflow is performed; and
a workflow engine to execute the workflow wherein the workflow information drives at least in part the electronic workflow performed by the engine and wherein the workflow engine records an audit trail in response to execution of the workflow, the electronic audit trail serving to at least help establish that a workflow executed on the workflow engine is compliant with one or more of the regulatory requirements.

23. A system according to claim 22 further wherein the regulatory guidelines are divided into practice areas and each area has several workflows targeting different processes that are to be used to address the broad guidelines specified in the practice area.

24. A system according to claim 22 further wherein the workflow is aware of the practice area and implements policies to enforce SEC regulations.

25. A system according to claim 22 wherein the practice area is insider trading.

26. A system comprising:
one or more data storage mediums to store a workflow data structure containing electronically accessible information indicative of an automated workflow used to perform the work of a information worker, wherein the information contained by the workflow data structure is adapted to enforce automated compliance with one or more regulatory requirements when the automated workflow is performed; and
an electronic workflow engine to execute the workflow using an electronic workflow engine wherein the workflow information drives at least in part the electronic workflow performed by the engine, electronic workflow causing an electronic audit trail to be recorded to establish that a workflow executed on the workflow engine is compliant with one or more of the regulatory requirements.

27. A system according to claim 26 further including prebuilt workflow components that can be configured in the workflow to reflect customized processes.

28. A system according to claim 26 further including extensible components built to address custom work items for specific organizations.
